(19) United States
(12) Patent Application Publication
(10) Pub. No.: US 2008/0246489 A1
(43) Pub. Date: Oct. 9, 2008

(54) Measuring Device For Impedance Spectroscopy and Associated Measuring Method

(75) Inventors: Hans Gerard Leonard Coster, Randwick (AU); Terry Calvin Chilcott, Sans Souci (AU); Stefan Lupke, Hamburg (DE); Torsten Muller, Berlin (DE); Thomas Schnelle, Berlin (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: EVOTEC TECHNOLOGIES GMBH, Dusseldorf (DE)

(21) Appl. No.: 10/599,649

(22) PCT Filed: Apr. 7, 2005
(86) PCT No.: PCT/EP05/03677

§ 371 Date: Jun. 16, 2008

(30) Foreign Application Priority Data
Apr. 8, 2004 (DE) 10 2004 017 474.1

(51) Int. Cl. G01N 27/02

(52) U.S. Cl. 324/446

(57) ABSTRACT

The invention relates to a measuring device and a measuring method for investigating particles which are suspended in a carrier liquid, including several measuring electrodes for carrying out electrical measuring of the particles. It is proposed that during electrical measuring, the particles be fixed in a field cage (4).

The invention relates to a measuring device for impedance spectroscopy of particles which are suspended in a carrier liquid, according to the pre-characterising part of claim 1, as well as to a corresponding measuring method according to the pre-characterising part of claim 39.

Impedance spectroscopy is for example known from COSTER et al.: “Impedance Spectroscopy of Interfaces, Membranes and Ultrastructures” (Bioelectro-chemistry and Bioenergetics 40: 79-98).

The known impedance spectroscopy is however associated with the disadvantage in that it is not suited to the investigation of single or small numbers of suspended cells or particles.

It is thus the object of the present invention to create a measuring device and a corresponding measuring method to make possible impedance spectroscopy of suspended cells or particles.

Starting with a known measuring device for impedance spectroscopy, this objective is met, according to the precharacterising part of claim 1, by the characterising features of claim 1 and—in relation to a corresponding measuring method—by the characteristics of claim 39.

The invention is based on the recognition that the reason why known impedance spectroscopy methods and devices are unsuitable for investigating single or small numbers of suspended cells or particles is because these known methods or devices require the cells which are to be investigated to be mechanically fixed (e.g. by way of negative pressure or surface functionalisation).

The invention therefore includes the general technical teaching that the suspended particles (e.g. cells) to be investigated within the scope of impedance spectroscopy be spatially fixed in order to make it possible to investigate suspended cells or particles, wherein such fixing, in contrast to the known methods or devices mentioned in the introduction, does not take place mechanically.

The term “particle” used in the context of the invention is used in a general sense; it is not limited to individual biological cells. Instead, this term also includes generally synthetic or biological particles. Particular advantages result if the particles include biological materials, i.e. for example biological cells, cell groups, cell components or biologically relevant macromolecules, if applicable in combination with other biological particles or synthetic carrier particles. Synthetic particles can include solid particles, liquid particles or multiphase particles which are delimited from the suspension medium, which particles constitute a separate phase in relation to the suspension medium, i.e. the carrier liquid.

Furthermore, as far as the investigation of particles is concerned, the invention is not limited to impedance spectroscopy as mentioned in the introduction, but can also be implemented using other methods of investigation that subject particles to electrical characterisation.

During investigation, spatial fixing of the particles to be investigated preferably takes place by way of a trapping element, preferably by a switchable trapping element, which exposes the particles to be investigated to a force fields thus fixing said particles. The field cage is preferably a dielectrophoretic field cage which comprises several cage electrodes. The design and function of such a dielectrophoretic field cage is known per se; it has for example been described in MÜLLER, T. et al.: “A 3-D-Microelectrode system for handling and caging single cells and particles”, Biosensors and Bioelectronics 14 (1999), 247-256. The full extent of the contents of said publication is to be taken into account in the context of the present description so that there is no need to provide in this document a detailed description of the design and function of the dielectrophoretic field cage.

In a variant of the invention, the field cage comprises several cage electrodes, wherein at least one of the cage electrodes is also a measuring electrode for electrical measuring of particles. This provides an advantage in that no additional measuring electrodes are required since the existing cage electrodes of the field cage in addition assume the function of measuring electrodes.

For example, the field cage can comprise eight cage electrodes, of which four can be used as measuring electrodes. In this arrangement, the eight cage electrodes are preferably arranged at the corner points of a right parallel epiped. Preferably the cage electrodes which are arranged at the corner points of the bottom base area of the right parallel epiped are used as measuring electrodes. During the measuring process, the particle to be investigated can then be moved downward in the carrier current, into an area near the edge, where it can be investigated.

As an alternative, it is however also possible for the field cage to comprise only five cage electrodes which are arranged at the corner points of a pyramid, wherein the cage electrodes which are arranged at the corner points of the base area of the pyramid are preferably used as measuring electrodes.

Furthermore, it is also possible for the yield cage to comprise only four cage electrodes, which are preferably arranged in a plane. Such an arrangement is for example known from FUHR, G. et al.: “Levitation, holding and rotation of cells within traps made by high-frequency fields”, Biochim. Biophys Act. 1108, so that the full extent of the contents of said printed publication is to be taken into account in the context of the present description. In this arrangement, the cage electrodes are preferably arranged at the corner points of a rectangle. In this arrangement, the particle to be investigated is preferably drawn into the field cage by means of positive dielectrophoresis, if need be centred by means of negative dielectrophoresis and if applicable is then measured.

As an alternative, the particle can be fired at the bottom and centrally between the electrodes by way of negative dielectrophoresis and sedimentation.

In this context it should be mentioned that if only positive dielectrophoresis is used, the particle might cling to at least one electrode. However, this is not critical if the distance between electrodes is adequate.

Furthermore, the field cage can also comprise two annular electrodes for trapping particles. Such an arrangement is for example known from SCHNELLE, Th. et al.: “Trapping of viruses in high frequency electric field cages”, Naturwiss. 83, 172-176 (1996), so that the full extent of the contents of said printed publication is to be taken into account in the context of the present description. When compared to a field cage comprising eight cage electrodes, in this arrangement the group of the upper four cage electrodes and the group of the lower four cage electrodes have been replaced by an annular electrode for each group. Impedance measurement then takes place by four separate measuring electrodes which are used for supplying current and/or for voltage measuring.

The term “field cage” used within the context of this invention is thus used in a general sense, rather than being limited to known arrangements, which are for example described in the above-mentioned publication by MÜLLER, T. et al.: “A 3-D-Microelectrode system for handling and caging single cells and particles”. Instead, in the sense of the present invention, the term “field cage” comprises all electrode arrangements which are suitable for fixing suspended particles in a carrier current.

Further, the term “trapping element” used in this description is not restricted to the aforementioned field cage. Further, the term “trapping element” encompasses laser traps, trapping with magnetic forces and other types of trapping elements.

In impedance spectroscopy, preferably an alternating current (AC) is supplied at a specified settable frequency, wherein the resulting voltage developed between the voltage electrodes is measured to characterise the particle to be measured.

It should be mentioned that cage electrodes are preferably selected using an electrical trapping signal for fixing the particles, while in contrast to this, an electrical measuring signal is applied to the measuring electrodes, wherein the frequency of the trapping signal preferably differs from that of the measuring signal. In this arrangement, the frequency of the trapping signal can be selected to be above or below the frequency of the measuring signal. The measuring signal can for example be a current which is impressed in the region of the fixed particles, wherein additionally the current is measured which flows transversely or parallel to the impressed current. In practical application, it is envisaged that the voltage is measured such that the current path and the line between the voltage electrodes subtend an angle in relation to each other, preferably at an acute angle in relation to each other.

In contrast to the above, in another variant of the invention, the cage electrodes do not additionally function as measuring electrodes, so that in addition to the cage electrodes, separate measuring electrodes are provided, wherein the measuring electrodes are galvanically separated from the cage electrodes and can be selected independently of the cage electrodes.

In this arrangement, the cage electrodes can be selected in pairs in phase opposition, wherein the measuring electrodes are preferably arranged in a plane which is arranged mid-way between two cage electrodes which are selected in phase opposition. Such an arrangement of the measuring electrodes provides an advantage in that selection of the cage electrodes does not falsify the measuring results. This is because the signals of the adjacent cage electrodes, which are selected in phase opposition, cancel each other out in the location of the measuring electrodes which are arranged in between.

In order to avoid interfering electrical inductive disturbances from the cage electrodes to the measuring electrodes, it is however not mandatory for the measuring electrodes to be arranged precisely mid-way between the cage electrodes which are selected in phase opposition, so that the signals of the cage electrodes cancel each other out at the location of the measuring electrodes. Instead, it is preferred if the measuring electrodes are arranged such in relation to the cage electrodes that selecting the cage electrodes equally affects the electrical potential of the measuring electrodes, so that, irrespective of the selection of the cage electrodes, the two measuring electrodes are always on the same potential of the trapping field. In this way, voltage measuring between the measuring electrodes is then not influenced by the field generated by the field cage.

In this arrangement, the measuring electrodes are preferably arranged in a measuring plane, wherein the measuring plane of the measuring electrodes can for example be aligned essentially at a right angle in relation to the direction of the flow of the carrier liquid. However, as an alternative, it is also possible for the measuring plane of the measuring electrodes to be aligned essentially parallel in relation to the direction of flow of the carrier liquid. However, in relation to the alignment of the measuring plane of the measuring electrodes, the invention is not limited to the two options described above, but instead can also be implemented using other alignments of the measuring plane.

In a further preferred embodiment the measuring electrodes are positioned in the trapping field in such a way, that subgroups of the measuring electrodes are positioned on the same potential of the trapping field.

Preferably, the measuring device according to the invention also comprises a control circuit for electrically selecting the cage electrodes so as to fix, in the field cage, the particles to be investigated. The function of the fixing of particles in a dielectrophoretic field cage is for example described in SCHNELLE et al.: “Trapping in AC octode field cages” (Journal of Electrostatics 50: 17-29). The full extent of the contents of said publication is thus to be taken into account in the context of the present description so that for the purpose of avoiding repetition there is no need to provide in this document a detailed description of the function of dielectrophoretic fixing of particles.

Moreover, the measuring device according to the invention preferably also comprises a measuring circuit which is connected to the measuring electrodes. In relation to the design and function of such a measuring circuit, reference is made to the already mentioned publication by COSTER et al.

Preferably, the connection of the cage electrodes with the control circuit and the measuring circuit is by way of a controllable switchboard section which alternately connects the cage electrodes to the measuring circuit or to the control circuit, as desired.

Such an intermediate circuit of a controllable switchboard section is useful in particular where the cage electrodes also function as measuring electrodes.

Moreover, a controllable switchboard between the cage electrodes and the measuring circuit also makes it possible to carry out measuring at various sets of cage electrodes. For example, in impedance spectroscopy, the current used for measuring can be impressed on various cage electrodes by means of the switchboard section.

Such a switchboard section also makes it possible to separate the low-impedance control circuit from the field cage during measuring, so as to obtain high-impedance measuring positions.

Furthermore it may be preferred to use a measurement signal containing multiple frequency components. Using different subsets of electrodes frequency components may be localised separately. Especially in view of particles with non-linear electrical characteristics interaction between different frequency components may be utilised. In this case the voltage measurement may be based on frequency components generated by convolution in the frequency domain. In particular in combination with localisation of frequency components this may achieve an improvement of signal to noise ratio.

In view of computational noise reduction it could be preferred to use measurement currents with fluctuating localisation.

Further, the carrier liquid is preferably flowing within a channel having multi-layer walls. The walls of the channel preferably comprise an electrically insulating inner layer and an outer layer, which may consist of a glass slide. In a preferred embodiment the measuring electrodes are retracted between the outer layer and the inner layer of the channel wall. In this embodiment the inner layer comprises an opening at the place of measurement to enable current injection into the carrier liquid flowing within the channel. Therefore, only the edges of the measuring electrodes are exposed to the carrier liquid.

The opening in the inner layer of the channel wall is preferably circular, whereas the current injecting electrode is preferably semi-circular having the same diameter as the opening in the inner layer of the channel wall.

Therefore, the exposed ends of the measuring electrode preferably have the circular geometry of the opening in the inner layer and therefore the direction of current flow is directed towards the center of the opening where the tips of the voltage electrodes can be located to maximize the response to the current. Thereafter the direction of flow will become increasing directed normal to the glass slide towards the trapped particle.

In this embodiment, laser tweezers can be used for positioning of cells between EIS electrodes. Further, the electrode tips can be made of a transparent material (e.g. ITO).

The afore-mentioned embodiment of the invention has the following advantages:
Minimization of the surface area of the measuring (EIS) electrodes that, like the dielectrophoretic electrodes, protrude into the cage—this was required to minimize contributions of the medium to impedance (capacitance) measurements
Location of the measuring (EIS) electrodes for injecting current as close as possible to cells/beads—this was required to maximize the proportion of the total current that flows through cells or beads
Location of the measuring (EIS) electrodes for measuring the voltage response to where that response will be a maximum—this was required to maximize the contribution of cells or beads to the voltage response to the injected current.

In another embodiment of the invention the current injecting electrode is split into several (e.g. three) sections that can be electrically connected on a printed circuit board to which the top and bottom slides are eventually attached. Thus splitting the EIS electrodes does not compromise significantly the total surface area. But it readily accommodates the eight electrodes required for dielectrophoresis. This design has the following advantages:
Current injecting electrodes no longer need to protrude into the insulating layer openings, and will not impinge on space where the voltage-sensing electrodes and dielectrophoretic electrodes predominate
Voltage-sensing electrodes can be positioned to maximize the response of the particles to the injected current
The current regimes for dielectropheresis and EIS are further separated in space potentially enhancing the accuracy of simultaneous EIS characterizations and dielectrophoresis.

Furthermore, it must be mentioned that the invention is not limited to the above-described measuring device according to the invention, but also comprises a microfluidic system with such a measuring device, as well as a cell sorter with such a microfluidic system.

Moreover, the invention also comprises a corresponding method; a point which has already become evident from the above description.

Preferably, within the context of the measuring method according to the invention, apart from the actual measuring of the particles which are to be investigated, reference measuring also takes place, which can for example be carried out with the field cage empty, wherein the result of reference measuring is subsequently compared or correlated to the result of the actual electrical measuring of the particles to be investigated. In this way, that signal fraction can advantageously be filtered out, which signal fraction as an effective signal reflects the electrical characteristics of the particles to be investigated, while the disturbance fraction which is caused by the measuring arrangement and in particular by the carrier current is filtered out.

Other advantageous improvements of the invention are characterised in the subordinate claims or result from the following description of the preferred embodiments of the invention in conjunction with the drawings. The following are shown:

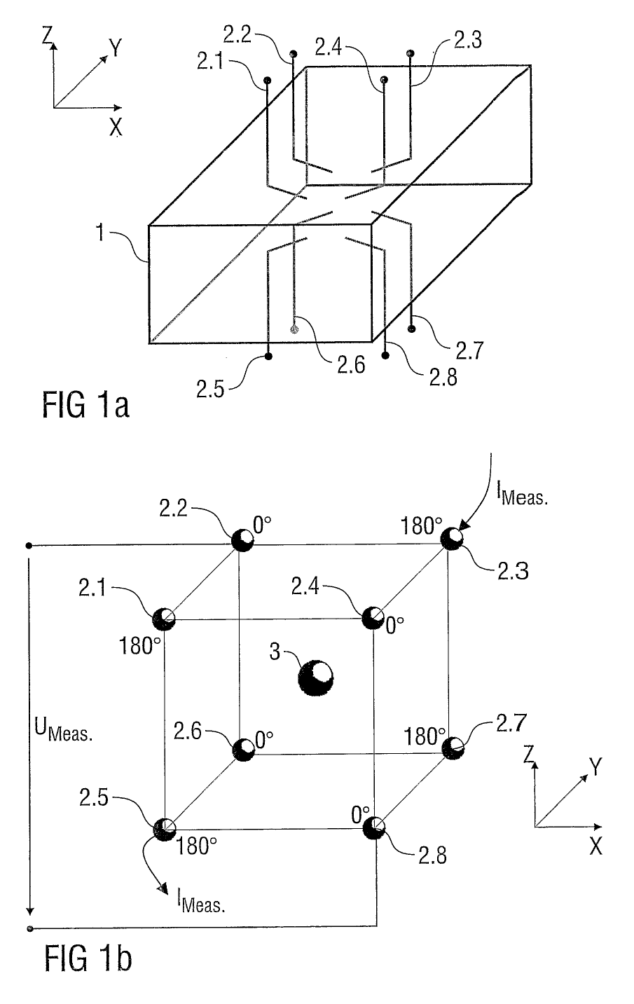

FIG. 1a a simplified perspective view of a carrier-current channel comprising a dielectrophoretic field cage arranged therein;

FIG. 1b a diagrammatic view showing the geometric arrangement of the cage electrodes with the field cage shown in FIG. 1a;

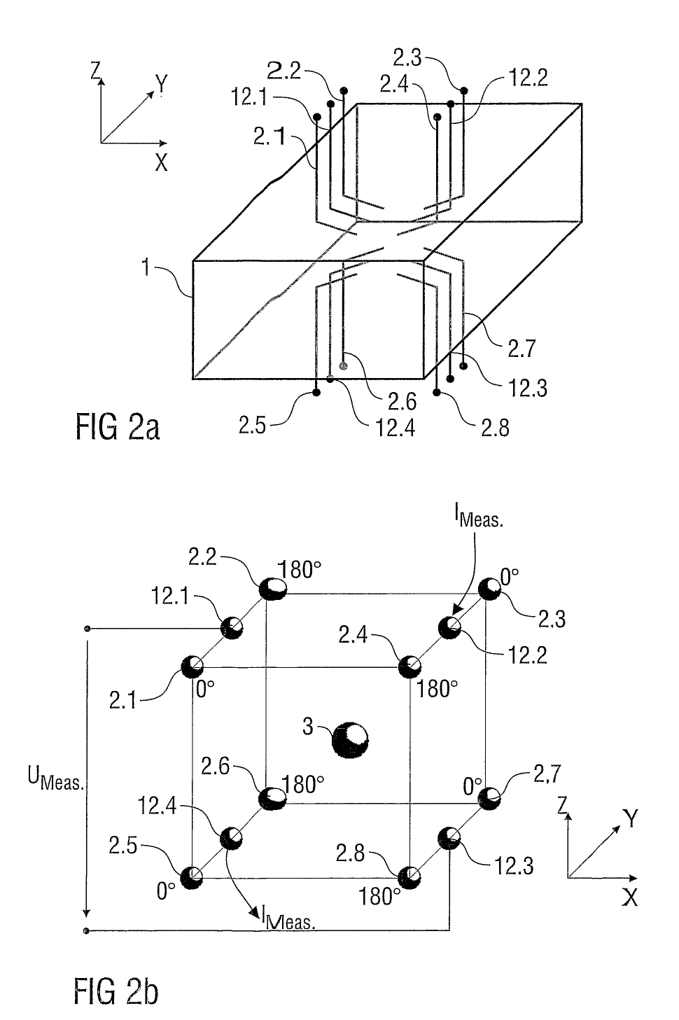

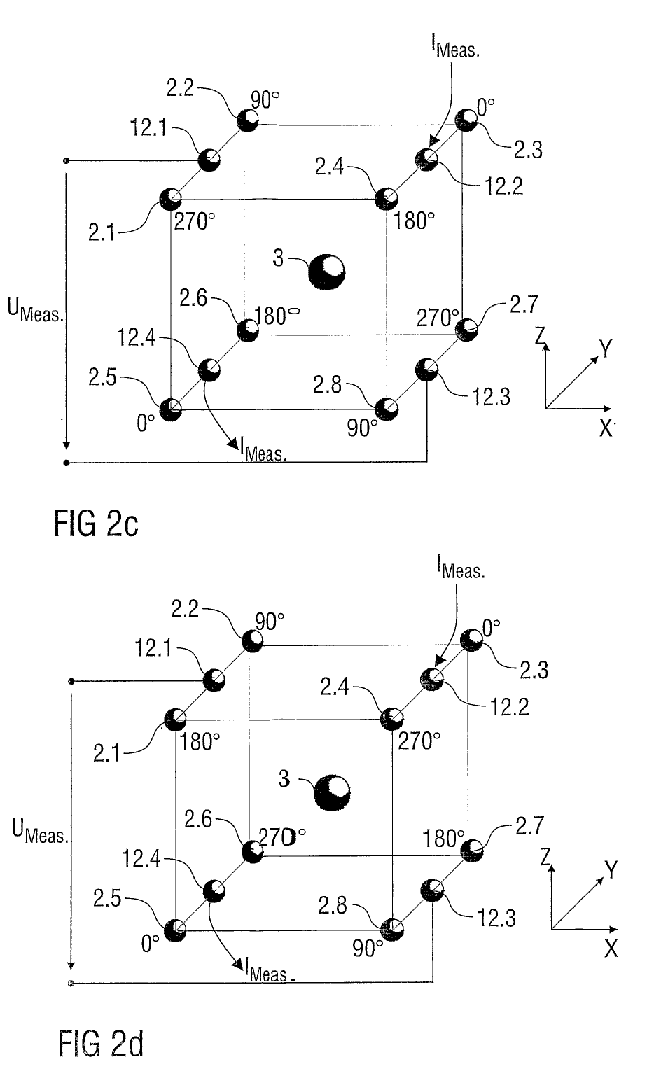

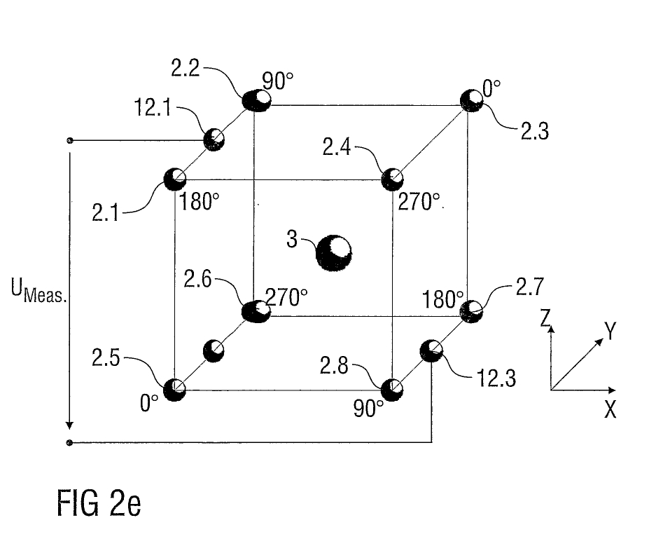

FIG. 2a a simplified perspective view of a carrier current with an alternative embodiment of a dielectrophoretic field cage with additional measuring electrodes;

FIG. 2b a diagrammatic view showing the geometric arrangement of the cage electrodes and of the measuring electrodes in the embodiment according to FIG. 2a;

FIGS. 2c-2e diagrammatic views of cage electrodes in other embodiments of the invention;

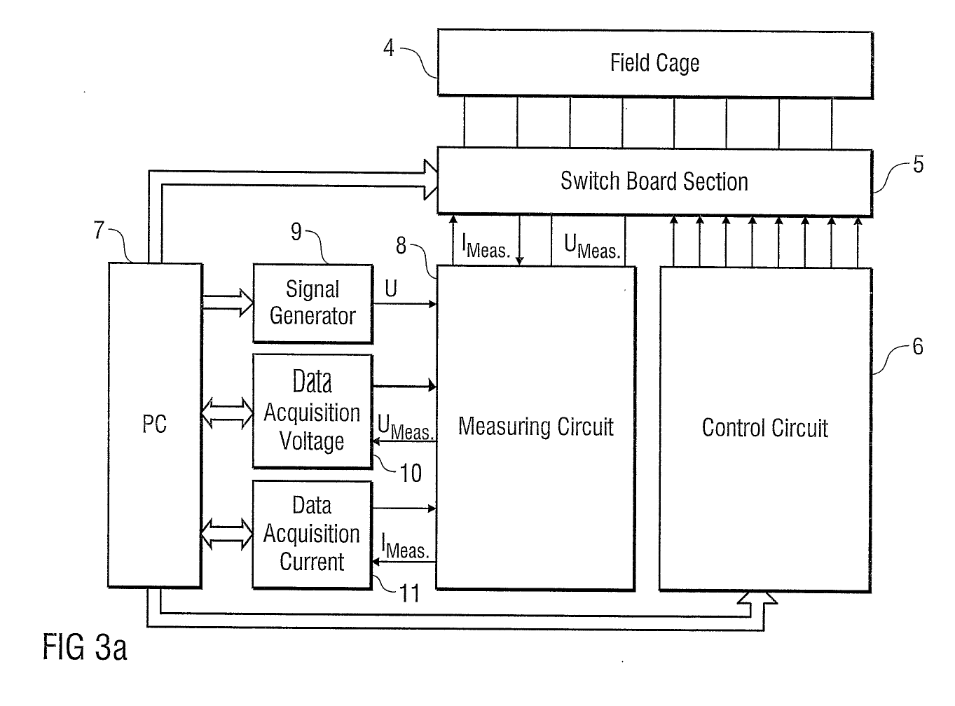

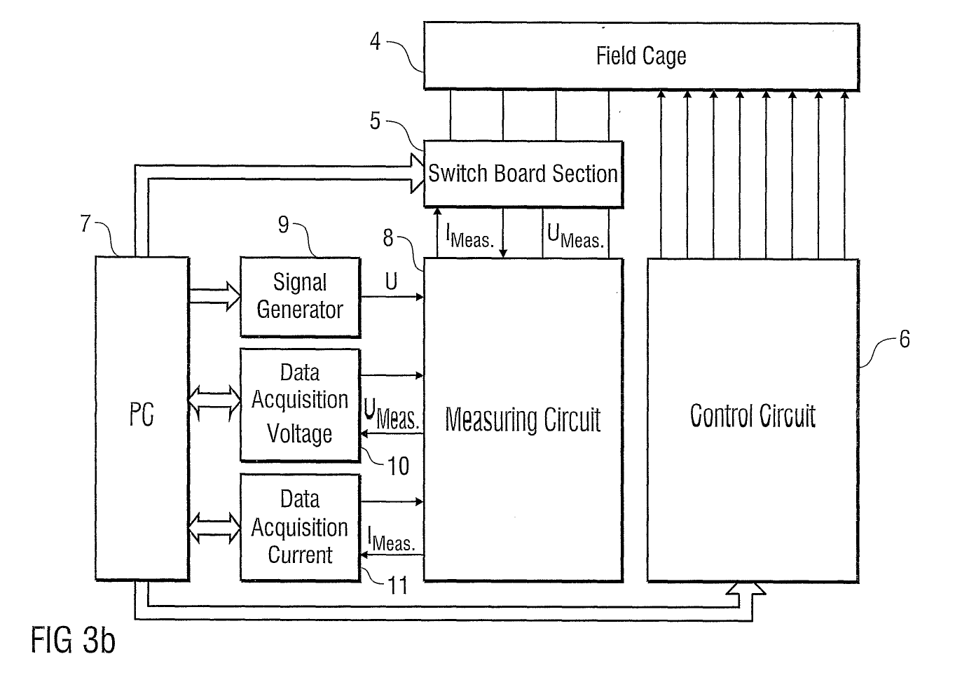

FIG. 3a an embodiment of a measuring device according to the invention with the field cage according to FIGS. 1a and 1b;

FIG. 3b an alternative embodiment of a measuring device according to the invention for the field cage in FIGS. 2a and 2b;

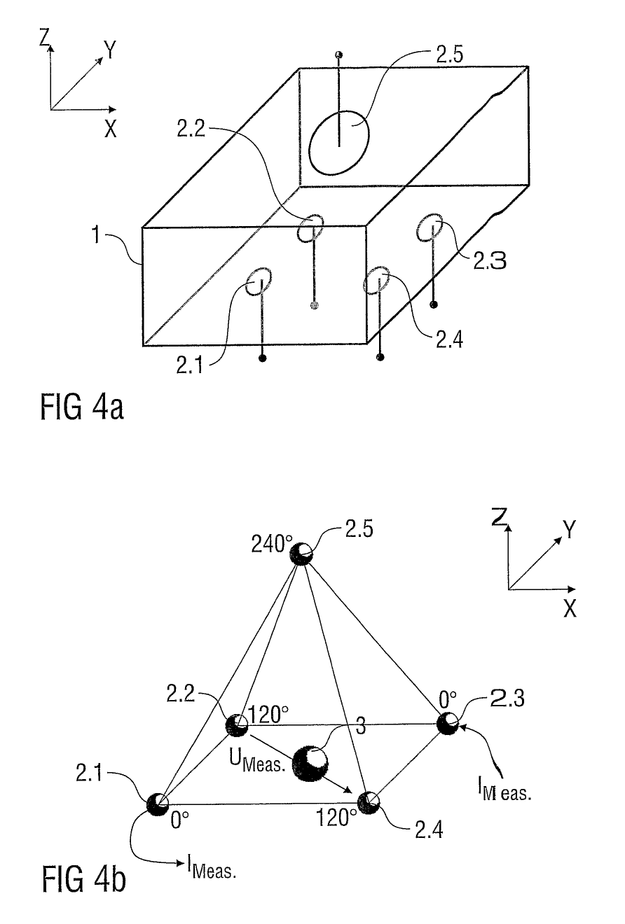

FIG. 4a a simplified perspective view of a carrier-current channel comprising a dielectrophoretic field cage with five cage electrodes;

FIG. 4b a diagrammatic representation showing the geometric arrangement of the cage electrodes in the embodiment according to FIG. 4a;

FIG. 5 a diagrammatic representation of a field cage comprising four separate measuring electrodes;

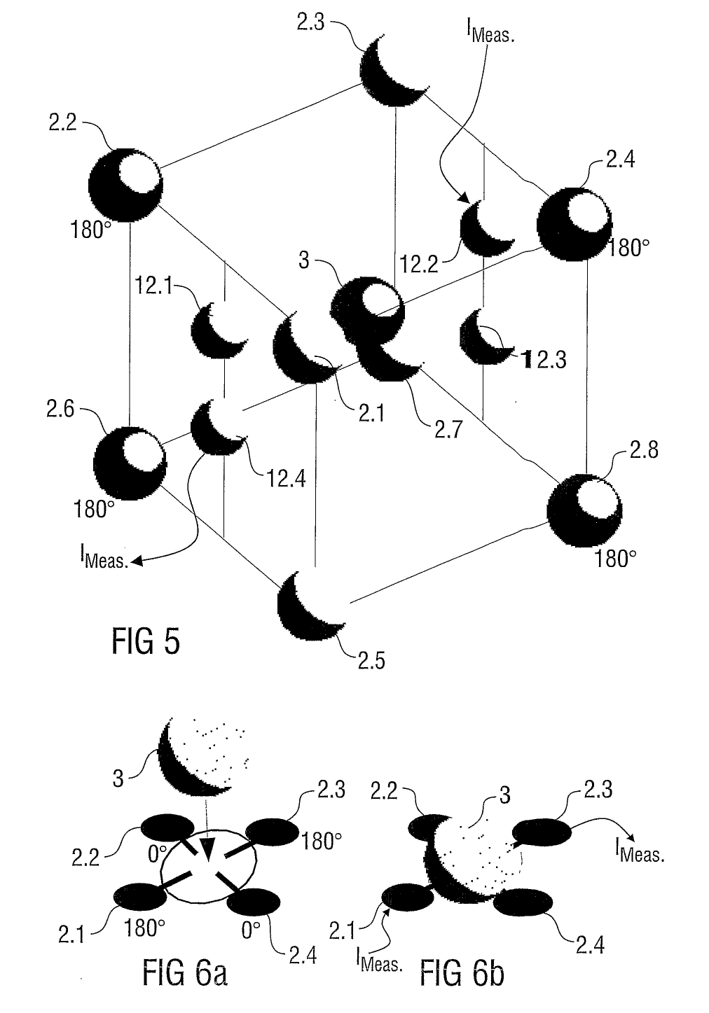

FIGS. 6a, 6b an electrode arrangement comprising four cage electrodes or measuring electrodes;

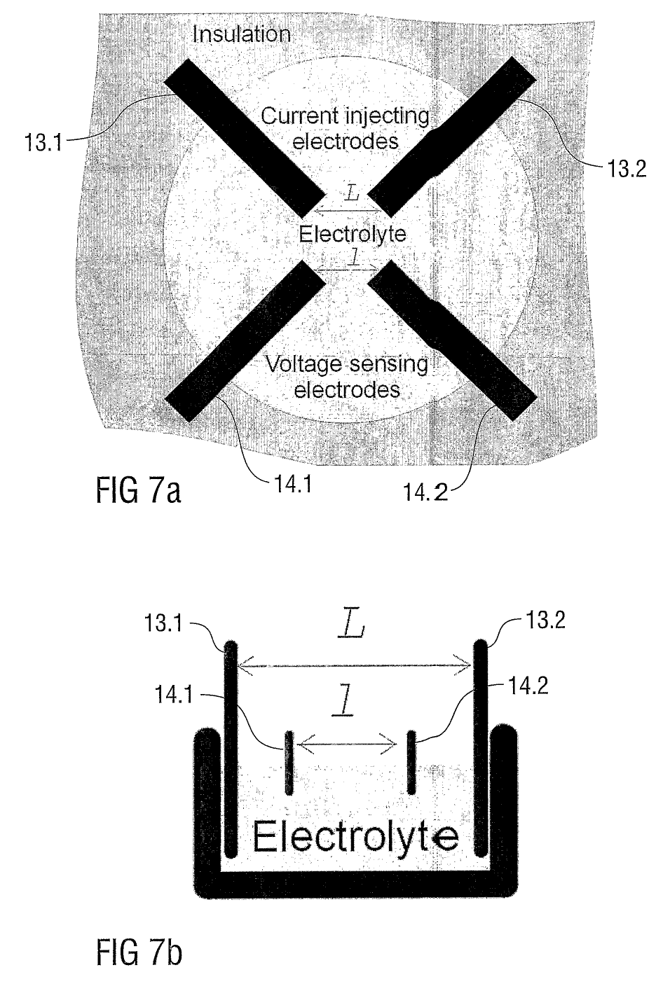

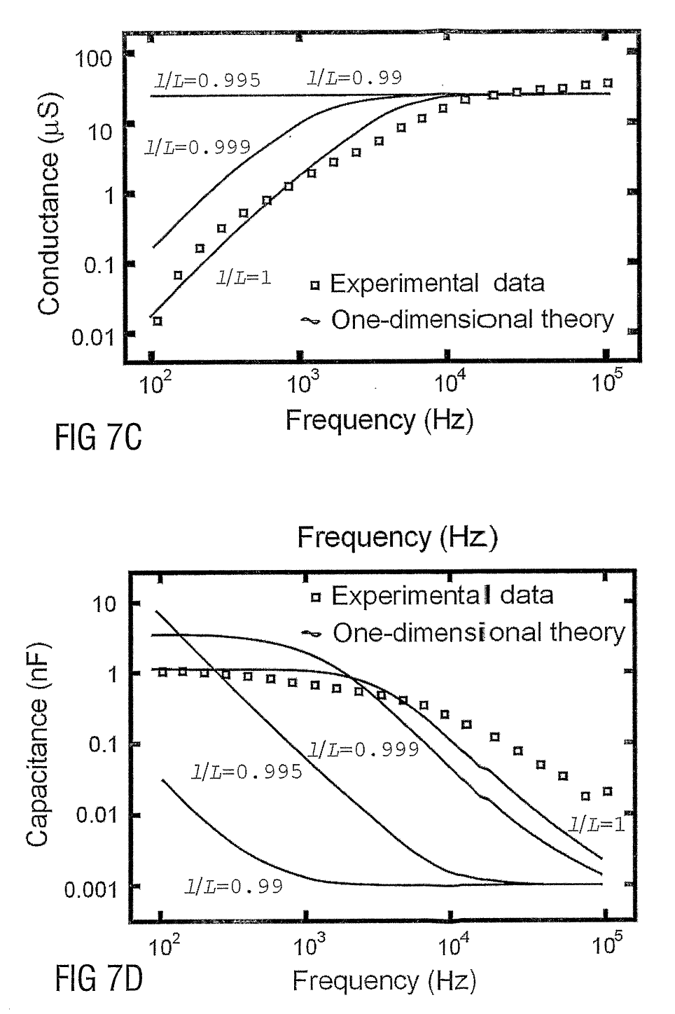

FIGS. 7a, 7b another electrode arrangement according to the invention;

FIGS. 7c, 7d examples of impedance spectra of an empty cage according to FIGS. 7a and 7b;

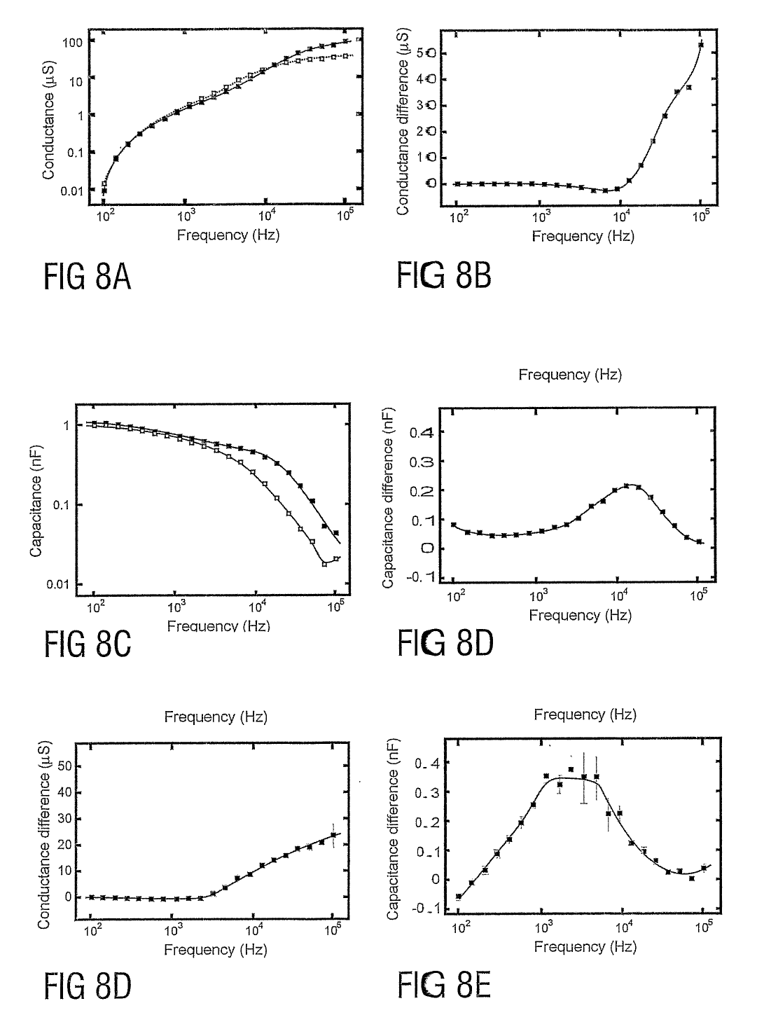

FIGS. 8a-8f examples of impedance spectra of cells;

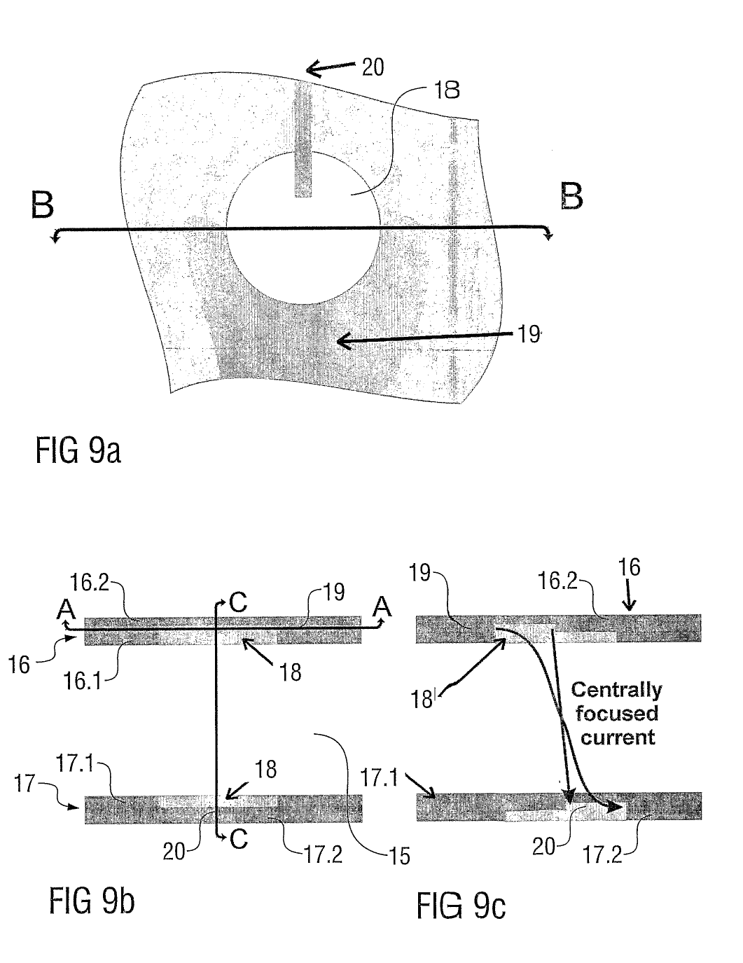

FIGS. 9a-9c different views of another embodiment of a measurement device with a semi-circular current injecting electrode;

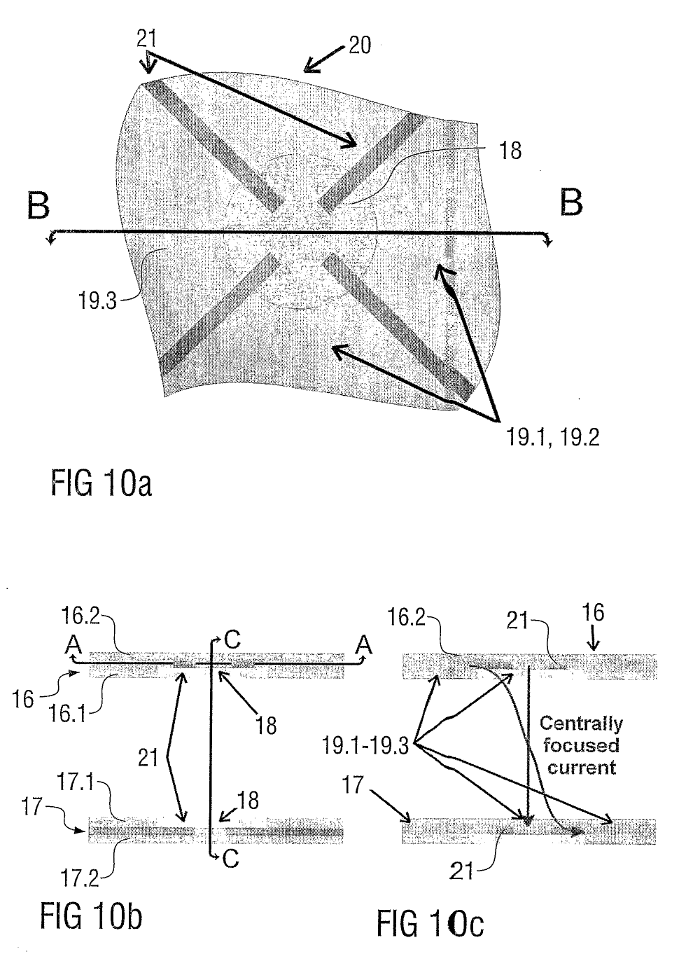

FIGS. 10a-10c different views of another embodiment of a measurement device in which the current injecting electrode is splitted into three sections;

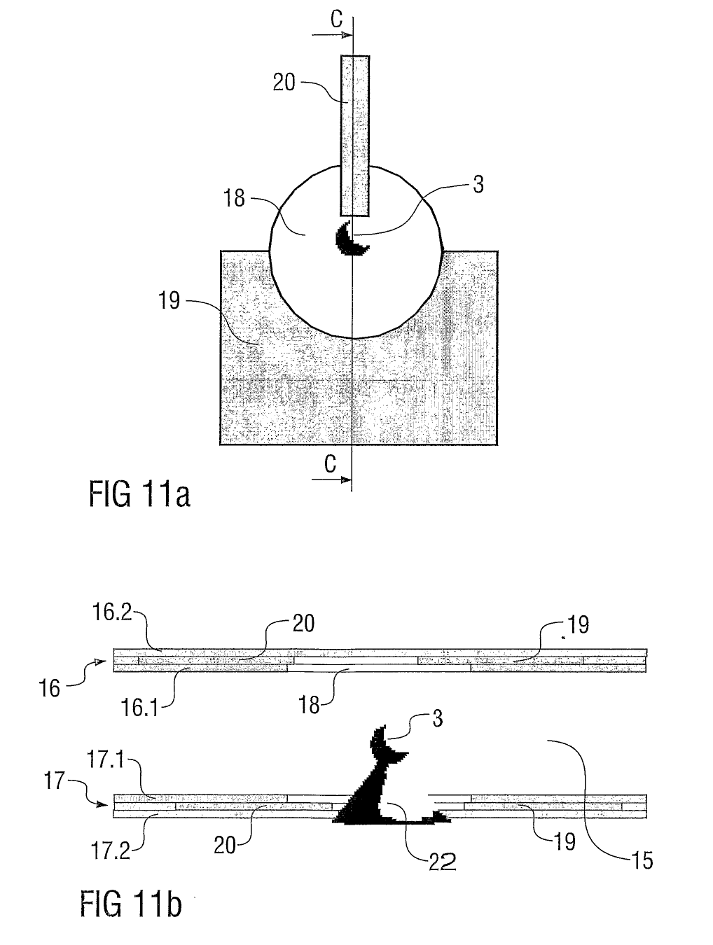

FIGS. 11a, 11b different views of another embodiment of a measurement device comprising a laser tweezer for the positioning of particles.

The perspective view in FIG. 1a shows a section of a carrier-current channel 1 in which a carrier current with particles suspended therein flows in the direction Y. In this arrangement, the carrier-current channel 1 forms part of a microfluidic system which can for example be used in a cell sorter. The design and function of the microfluidic system and the cell sorter are otherwise conventional and are thus not described in further detail.

Arranged in the carrier-current channel 1 is a dielectrophoretic field cage comprising eight cage electrodes 2.1-2.8, wherein the tips of the cage electrodes 2.1-2.8 are positioned at the corner points of a right parallel epiped of uniform edge length. The dielectrophoretic field cage makes it possible to fix particles which are suspended in the carrier current, wherein the function of the dielectrophoretic field cage is for example described in the above-mentioned publications by MÜLLER, T. et al.: “A 3D Microelectrode system for handling and caging single cells and particles”, and SCHNELLE et al.: “Trapping in AC octode field cages”, so that there is no need to provide a detailed description of the function of a dielectrophoretic field cage in this document.

FIG. 1b particularly clearly shows the geometric arrangement of the individual cage electrodes 2.1-2.8, wherein the dielectrophoretic field cage fixes a particle 3 in its centre. Apart from showing the individual cage electrodes 2.1-2.8, the phase position is shown with which the individual cage electrodes 2.1-2.8 are selected.

In this arrangement, supplying the current, and voltage measuring preferably take place diagonally through the field cage. The current path and/or the voltage difference path for impedance spectroscopy measuring thus preferably extend/extends diagonally through the field cage.

Below, the design and function of the measuring device according to the invention are described with reference to the simplified block diagram, wherein the measuring device comprises a dielectrophoretic field cage 4 as described above with reference to FIGS. 1a and 1b.

By way of a controllable switchboard section 5, the cage electrodes 2.1-2.8 of the field cage 4 are connected to a control circuit 6 which can be of a conventional design and which selects the cage electrodes 2.1-2.8 such that the particle 3 is trapped in the field cage 4 and spatially fixed. In this arrangement the control circuit 6 in turn is selected by a computer 7, for example so as to trap only certain particles 3 in the field cage 4.

Furthermore, if it is selected correspondingly by the computer 7, the controllable switchboard section 5 also makes it possible for the cage electrodes 2.1-2.8 to be connected to a measuring circuit 8 for impedance spectroscopy investigation of the particle 3 trapped in the field cage 4. The measuring circuit 8 can largely be of conventional design so that, to a large extent reference is made to the above-mentioned publication by COSTER et al.: “Impedance Spectroscopy of Interfaces, Membranes and Ultrastructures”.

On the input side, the measuring circuit 8 is connected to a signal generator 9 which again is selected by the computer 7 and which provides the measuring circuit 8 with a voltage signal U, whose frequency can be set to between 10⁻³ Hz and 1 GHz and whose amplitude ranges from 0-2 volt. However, the frequency spectrum actually scanned in impedance spectroscopy depends on the size, structure and electro- and/or bio-chemical properties of the particles to be investigated, as well as on the conductance, dielectric and electro-chemical properties of the suspending fluid. For example, the useful frequency range for impedance spectroscopy of cell membranes in physiologically relevant fluids ranges from 0.001 Hz to 100 kHz, whereas for the purpose of measuring the interior of cells, frequencies in the megahertz range are also used.

The computer 7 selects the switchboard section 5 such that alternately the control circuit 6 or the measuring circuit 8 is connected to the field cage 4 in order to fix the particle 3 in said field cage 4 and in the meantime carry out an impedance-spectroscopy investigation of the particle 3 in its fixed state.

For the purpose of an impedance spectroscopy investigation, the switchboard section 5 connects the cage electrodes 2.3 and 2.5 as well as 2.2 and 2.8 to the measuring circuit 8.

Corresponding to the voltage signal U provided by the signal generator 9, the measuring circuit 8 impresses a corresponding current onto the cage electrode 2.3; in this way the current circuit is closed by way of the opposite cage electrode 2.5. At the cage electrodes 2.2 and 2.8, the measuring circuit 8 then measures the voltage at the respective frequency of the voltage signal provided by the signal generator 9, and conveys the voltage value to a data acquisition circuit 10 which conveys the measured voltage to the computer 7.

Furthermore, the measuring circuit 8 also measures the current which flows by way of the cage electrodes 2.3 and 2.5, and outputs this current to a data acquisition circuit 11 which on the output side is also connected to the computer 7.

With a corresponding variation in the frequency of the signal generator 9, the computer 7 can then carry out impedance spectroscopy measuring from the measured current values and voltage values.

In this arrangement the cage electrodes 2.3, 2.5, 2.2, 2.8 are thus used quasi-bi-functionally as measuring electrodes, so that there is no need for additional measuring electrodes for carrying out impedance spectroscopy measuring.

Furthermore, it is advantageous if the switchboard section 5 can connect the measuring circuit 8 also to other cage electrodes as measuring electrodes in order to obtain additional information.

The embodiment of a carrier-current channel, shown in FIGS. 2a and 2b, with a dielectrophoretic field cage located therein, largely agrees with the embodiment shown in FIGS. 1a and 1b, so that in order to avoid repetition reference is made to the above description, with the same reference characters being used for corresponding components.

However, this embodiment comprises a special feature in that impedance spectroscopy investigation does not take place by means of the cage electrodes 2.1-2.8. Instead, this arrangement provides for four separate measuring electrodes 12.1-12.4 for impedance spectroscopy investigation.

In this arrangement, the measuring electrodes 12.1-12.4 are positioned in a plane and are arranged mid-way between two adjacent cage electrodes. This is advantageous because the adjacent cage electrodes 2.1-2.8 are selected in pairs in phase opposition. Thus, in this arrangement the cage electrodes 2.1, 2.5, 2.3 and 2.7 on the one hand, and the cage electrodes 2.2, 2.6, 2.4, and 2.8 on the other hand are selected in phase opposition. This is advantageous because the electrical signals, present at the cage electrodes 2.1-2.8, for trapping the particle 3 in the field cage 4 in this way mutually cancel each other out at the location of the measuring electrodes 12.1-12.4 so that no electrical disturbances occur between the cage electrodes 2.1-2.8 and the measuring electrodes 12.1-12.4.

Furthermore, it should be mentioned that the measuring electrodes 12.1-12.4 are arranged in a measuring plane which is aligned at a right angle in relation to the direction of flow in the carrier-current channel 1. However, as an alternative, it is possible for the measuring electrodes 12.1-12.4 to be arranged in a measuring plane which is aligned in some other way.

FIG. 2c largely agrees with the embodiment shown in FIG. 2b, so that in order to avoid repetition reference is made to the above description, with the same reference characters being used for corresponding components. However, this embodiment comprises special rotational excitation of the cage electrodes 2.1-2.8 (see also MÜLLER et al.). As in FIG. 2b no electrical disturbances occur between the cage electrodes 2.1-2.8 and the impedance measuring electrodes 12.1-12.4. Due to rotational excitation of the electrodes and depending on frequency of trapping field, the particle 3 can be rotated along the y axis thus enabling impedance tomography. In a further preferred embodiment the cage excitation is switched to ac shown in FIG. 2b during impedance measurements. Repeating this procedure enables impedance measurements of the cell at rest and at defined angles.

FIG. 2d largely agrees with the embodiment shown in FIG. 2c, so that in order to avoid repetition reference is made to the above description, with the same reference characters being used for corresponding components. However, this embodiment comprises rotational excitation of the cage electrodes 2.1-2.8 (see also MÜLLER et al.) that can induce particle rotation around the z-axis for impedance tomography. In this case electrical disturbances occur between the cage electrodes 2.1-2.8 and the measuring electrodes 12.1-12.4. Impedance measurements are still possible because the trapping field does not create voltage differences between the voltage measuring electrodes 12.1 and 12.3 used for impedance measurements and the impedance current injecting electrodes 12.2 and 12.4, respectively.

FIG. 2e largely agrees with the embodiment shown in FIG. 2d, so that in order to avoid repetition reference is made to the above description, with the same reference characters being used for corresponding components. In this embodiment no separate current injecting electrodes 12.2 and 12.4 are present for impedance measurements. Instead the trapping electrodes 2.1-2.8 are additionally used as current injectors for the impedance measurements. Ideally, i.e. without a particle 3 or with an ideally spherical and centrally trapped particle no voltage difference between the voltage measuring electrodes would then be measured. An entering and or non ideal particle (such as a biological cell) will produce a voltage signal. It should be noted that this also works with the trapping field shown in FIGS. 2c-d.

The embodiment, shown in FIG. 3b, of a measuring device according to the invention largely agrees with the embodiment described above and shown in FIG. 3a so that in order to avoid repetition, reference is made to a large extent to the above description, with the same reference characters being used for corresponding components.

However, the measuring device according to FIG. 3b is used for selecting the carrier-current channel with the field cage 4 situated therein as shown in FIGS. 2a and 2b.

Because of the separation between the cage electrodes 2.1-2.8 and the measuring electrodes 12.1-12.4, the control circuit 6 can be permanently connected to the field cage 4.

The controllable switchboard section 5 thus merely serves the purpose of selecting particular measuring electrodes 12.1-12.4 for current supply or voltage measuring.

Finally, FIGS. 4a and 4b show an alternative design of a carrier-current channel 1 with a field cage arranged therein, wherein this embodiment, too, largely agrees with the embodiments described above and shown in FIGS. 1a, 1b, 2a and 2b. In order to avoid repetition, reference is thus made to a large extent to the above description, wherein, below, the same reference characters have been used for corresponding components.

This embodiment comprises a special feature in that the field cage 4 comprises only five cage electrodes 2.1-2.5, each of which is located on a corner point of a pyramid, as shown in particular in FIG. 4b.

However, the field cage according to FIG. 4a also makes it possible to fix particles 3 in order to subject them to an impedance spectroscopy investigation.

In this arrangement the cage electrodes 2.1-2.4 are additionally used as measuring electrodes for impedance spectroscopy investigation so that there is no need to provide additional measuring electrodes.

The embodiment of a field cage diagrammatically shown in FIG. 5 largely agrees with that described above and shown in FIG. 2b so that in order to avoid repetition, to a large extent reference is made to the above description in the context of FIG. 2b, with the same reference characters being used for corresponding components.

This embodiment comprises a special feature in that the measuring electrodes 12.1-12.4 are not arranged exactly mid-way between two adjacent cage electrodes. Instead, in this arrangement, the measuring electrodes 12.1-12.4 are merely arranged in a mutual measuring plane, which extends mid-way between the following cage electrodes, arranged in phase opposition: 2.3, 2.7, 2.2 and 2.6 on the one hand, and 2.1, 2.5, 2.4 and 2.8 on the other hand. In this way, too, it is ensured that there is no mutual electrical interference between the measuring electrodes 12.1-12.4 on the one hand, and the cage electrodes 2.1-2.8 on the other hand.

Finally, the embodiment shown in FIGS. 6a and 6b largely agrees with the embodiment described above and shown in FIGS. 4a and 4b so that in order to avoid repetition, to a large extent reference is made to the above description in the context of FIGS. 4a and 4b, with the same reference characters being used for corresponding components.

This embodiment comprises a special feature in that only four cage electrodes 2.1-2.4 have been provided, wherein the cage electrodes 2.1, 2.3 on the one hand and the cage electrodes 2.2, 2.4 on the other hand are selected in phase opposition, as shown in the phase positions on the drawing.

By means of positive dielectrophoresis (pDEP) or electrophoresis, the particle 3 to be investigated is then preferably drawn to the centre of the cage electrodes 2.1-2.4 and is then investigated as shown in FIG. 6b using impedance spectroscopy.

For the purpose of impedance measuring, the particle to be investigated can be centrally fixed between the electrodes by superposition of negative dielectrophoresis and sedimentation. As an alternative, the particle can be drawn into the cage region by means of positive dielectrophoresis. Both methods can be applied in combination to the electrodes, with the use of various trapping frequencies and, if need be, various phase positions.

An example of a dielectrophoretic cage in which electrodes were used to measure the impedance of an inositol medium over a frequency range 10²-10⁵ Hz is shown in FIG. 7a. The measurements are expressed in terms of admittance, the reciprocal of impedance. The real part of the admittance, that is, conductance is shown in FIG. 7c (open square symbols), and the imaginary part of the admittance divided by the angular frequency ω, i.e. capacitance, in FIG. 7c (open square symbols).

The area specific admittance of a medium of conductivity σ, dielectric permittivity ∈, Debye length λ and diffusion constant D, using parallel current-injecting electrodes 13.1, 13.2 located at ±½L and small voltage sensing electrodes 14.1, 14.2 located at ±½l, as shown in FIG. 7b, are for example known from COSTER and CHILCOTT: “The characterization of membranes and membrane surfaces using impedance spectroscopy” (Surface chemistry and electrochemistry of membranes 19: 749-793). This admittance is given by (σ/l+jω∈/l)/(1+σδ/jω∈) where δ≡(²/_{κl}) Sin h (^{κl}/₂)/Cos h (^{κL}/₂), κ²≡1/λ²+jω/D and j²≡−1. Theoretical dispersions of conductance and capacitance of inositol medium (σ≡15 mS/m, ∈≈75×8.854 pF, λ≈9.4 nm, D≈2×10⁻⁹ m²/s) in such a system are also shown in FIGS. 7c and 7d, respectively, for a system with L≈20 μm, a similar spacing for current-injecting electrodes 13.1, 13.2 in the cage, and an electrode area of ≈3×10⁻⁸ m².

FIGS. 7c and 7d illustrate that the theoretical dispersions at low frequencies are extremely sensitive to the spacing (l) of the voltage-sensing electrodes 14.1, 14.2. The sensitivity diminishes with increasing frequency yielding constant conductive and capacitive properties of the medium at sufficiently high frequencies. The theoretical dispersions for l=L predict the general form and order-of-magnitude of dispersions measured using the cage electrodes 13.1, 13.2, 14.1, 14.2 (open square symbols). The theoretical dispersions further show that the geometrical condition l<0.99 L yields constant capacitive and conductive properties in the frequency range (10²-10⁵ Hz).

FIG. 8a and FIG. 8c show that the presence of trapped cells (see dispersions identified by filled square symbols) modulate the reference dispersions (open square symbols). The simple one-dimensional theory illustrates that optimisation of the electrode configuration and geometry can optimise the contribution of cells to measurements of the total impedance.

FIG. 8b shows the differences in conductance arising from the presence of trapped cells (cluster of 3 K562-cells) and FIG. 8d shows the differences in capacitance. FIGS. 8e and 8f are, respectively, conductance and capacitance differences for cells at a different stages of maturation. A comparison of these Figures with FIGS. 8b and 8d, respectively, reveals common features: a positive capacitance difference over the frequency range (10²-10⁵ Hz), consistent with the presence of membrane structure; a conductance through mid-range, consistent with known low-conduction properties of cell membranes; and a pronounce increase in conductance with further increases in frequency, consistent with known decreases in the impedance of the membrane (capacitance) with increasing frequency revealing the high-conduction properties of the cytoplasm of cells. The magnitude, spread and location of such features reflect differing structural, electro- and/or bio-chemical properties of cells at different stages of maturation.

FIGS. 9a to 9c show different views of another embodiment of a measuring device according to the invention. FIG. 9a is a top view, whereas FIG. 9b is a sectional view along line B-B in FIG. 9a. Further, FIG. 9c is a sectional view along line C-C in FIG. 9b. Finally, FIG. 9a is a sectional view along line A-A in FIG. 9b.

These views show a fluid channel 15 containing a carrier liquid in which particles (e.g. biological cells) are suspended. The fluid channel 15 is confined by an upper wall 16 and a lower wall 17. Both the upper wall 16 and the lower wall 17 of the fluid channel 15 comprise an electrically insulating inner layer 16.1, 17.1 and an outer layer 16.2, 17.2 formed by a glass slide. A circular opening 18 is formed in the inner layer 16.1 of the upper wall 16. Further, a current injecting electrode 19 is arranged between the outer layer 16.2 and the inner layer 16.1 of the upper wall 16. The current injecting electrode 19 is semicircular, which can be seen in FIG. 9a, having the same diameter as the opening 18 in the inner layer 16.1 of the upper wall 16. Therefore, only the edges of the current injecting electrode 19 are exposed to the carrier liquid flowing within the fluid channel 15. The exposed ends of the current injecting electrode 19 have the circular geometry of the opening 18 and therefore the direction of current flow is directed towards the center of the opening 18 where the tips of the voltage electrodes can be located to maximize the response to the current. Thereafter the direction of flow will become increasing directed normal to the glass slide towards the trapped particle. Further, the measuring device comprises a voltage sensing electrode 20 for measuring the electrical potential caused by the injected current.

This design offers the following advantages:
Minimization of the surface area of EIS electrodes that, like the dielectrophoretic electrodes, protrude into the cage—this was required to minimize contributions of the medium to impedance (capacitance) measurements.
Location of EIS electrodes for injecting current as close as possible to cells/beads—this was required to maximize the proportion of the total current that flows through cells or beads.
Location of EIS electrodes for measuring the voltage response to where that response will be a maximum—this was required to maximize the contribution of cells or beads to the voltage response to the injected current.

FIGS. 10a to 10c show different views of another embodiment of a measuring device according to the invention. FIG. 10a is a top view, whereas FIG. 10b is a sectional view along line B-B in FIG. 10a. Further, FIG. 10c is a sectional view along line C-C in FIG. 10b. Finally, FIG. 10a is a sectional view along line A-A in FIG. 10b.

The embodiment shown in FIGS. 10a to 10c is similar to the embodiment shown in FIGS. 9a to 9c so that reference is made to above description.

Further, FIGS. 10a to 10c show eight dielectrophoresis electrodes 21 which are omitted in FIGS. 9a to 9c for sake of clarity.

It is a characteristic of this embodiment that the current injecting electrode 19 is split into three sections 19.1-19.3 sections that can be electrically connected on the double-sided printed circuit board to which the top and bottom slides are eventually attached. Thus splitting the current injecting electrode 19 does not compromise significantly the total surface area. But it readily accommodates the eight dielectrophoresis electrodes 21.

This design offers the following advantages:
The current injecting electrode 19 no longer need to protrude into the insulating overlay openings 18, and will not impinge on space where the voltage-sensing electrodes 20 and dielectrophoretic electrodes 21 predominate.
The Voltage-sensing electrodes 20 can be positioned to maximize the response of the particles to the injected current.
The current regimes for dielectrophoresis and EIS are further separated in space potentially enhancing the accuracy of simultaneous EIS characterizations and dielectrophoresis.

Finally, FIGS. 11a and 11b show another embodiment of a measuring device according to the invention. FIG. 11a is a top view of the measuring device, whereas FIG. 11b is a sectional view of the measuring device along line C-C in FIG. 11a.

The embodiment shown in FIGS. 11a and 11b is similar to the embodiment shown in FIGS. 9a to 9c so that reference is made to above description.

One characteristic of this embodiment is that a laser tweezer 22 is used for positioning the particles 3 (e.g. biological cells) between EIS electrodes. In this embodiment the electrode tips could be made of a transparent material (e.g. ITO).

The invention is not limited to the embodiments described above, which are preferred embodiments. Instead, a multitude of variants and modifications are possible which also make use of the inventive concept and thus fall within the range of protection.

### LIST OF REFERENCE CHARACTERS

1 Carrier-current channel
2.1-2.8 Cage electrodes
3 Particle
4 Field cage
5 Switchboard section
6 Control circuit
7 Computer
8 Measuring circuit
9 Signal generator
10 Data acquisition circuit
11 Data acquisition circuit
12.1-12.4 Measuring electrodes
13.1, 13.2 Current injecting electrodes
14.1, 14.2 Voltage sensing electrodes
15 Fluid channel
16 Upper wall
16.1 Inner layer
16.2 Outer layer
17 Lower wall
17.1 Inner layer
17.2 Outer layer
18 Opening
19 Current injecting electrode
20 Voltage sensing electrode
21 dielectrophoresis electrodes
22 Laser tweezer

1-48. (canceled)

49. A measuring device for investigating particles which are suspended in a carrier liquid, comprising:
a) at least two measuring electrodes for carrying out an electrical measuring of the particles; and
b) a trapping element for fixing the particles for the electrical measuring, wherein the trapping element is a field cage comprising a plurality of cage electrodes.

50. The measuring device according to claim 49, wherein at least one of the cage electrodes is also a measuring electrode.

51. The measuring device according to claim 49, wherein an electrical trapping signal for fixing the particles is present at the cage electrodes, and an electrical measuring signal is present at the measuring electrodes.

52. The measuring device according to claim 51, wherein a frequency of the trapping signal is different from a frequency of the measuring signal.

53. The measuring device according to claim 52, wherein the trapping signal is present before the measuring signal.

54. The measuring device according to claim 52, wherein the trapping signal is present during the measuring signal.

55. The measuring device according to claim 52, wherein the trapping signal is present after the measuring signal.

56. The measuring device according to claim 49, wherein the field cage comprises a plurality of cage electrodes, wherein the measuring electrodes are galvanically separated from the cage electrodes and can be selected independently of each other.

57. The measuring device according to claim 49, wherein the measuring electrodes comprise at least two electrodes for supplying current, and at least two electrodes for measuring a voltage.

58. The measuring device according to claim 49, wherein the measuring electrodes comprise two electrodes for both supplying current and measuring a voltage.

59. The measuring device according to claim 49, wherein the measuring electrodes comprise two electrodes for supplying current and a third electrode that uses any one of the other measuring electrodes or remaining cage electrodes as a reference electrode for measuring voltage.

60. The measuring device according to claim 49, wherein the measuring electrodes comprise two electrodes for supplying current and two electrodes for measuring voltage.

61. The measuring device according to claim 49, wherein the measuring electrodes comprise at least two electrodes for supplying current.

62. The measuring device according to claim 49, wherein the measuring electrodes comprise at least two electrodes for measuring voltages.

63. The measuring device according to claim 59, wherein the electrodes used for measuring the voltage are arranged in relation to the cage electrodes such that the voltage between the electrodes used for measuring the voltage is not influenced or minimally influenced by a trapping signal present at the cage electrodes.

64. The measuring device according to claim 57, wherein the cage electrodes are driven in pairs in phase opposition, wherein at least one of the measuring electrodes is arranged in a plane which extends between two of the cage electrodes, which are driven in phase opposition.

65. The measuring device according to claim 49, wherein the measuring electrodes are arranged in a measuring plane.

66. The measuring device according to claim 65, wherein the measuring plane of the measuring electrodes is essentially aligned at an angle in relation to a direction of flow of the carrier liquid.

67. The measuring device according to claim 65, wherein the measuring plane of the measuring electrodes is aligned essentially parallel in relation to a direction of flow of the carrier liquid.

68. The measuring device according to claim 49, wherein a current path extends between a pair of said measuring electrodes and a voltage measuring path extends between another pair of said measuring electrodes, wherein the voltage measuring path extends across the current path.

69. The measuring device according to claim 68, wherein the current path and the voltage measuring path essentially extend through the field cage.

70. The measuring device according to claim 49, wherein said electrical measuring comprises an impedance measuring.

71. The measuring device according to claim 70, wherein said electrical measuring comprises impedance measurements at a plurality of frequencies.

72. The measuring device according to claim 70, wherein said electrical measuring comprises an impedance spectroscopy measuring.

73. The measuring device according to claim 49, wherein said electrical measuring comprises an impedance tomography measuring.

74. The measuring device according to claim 49, wherein the field cage is a dielectrophoretic field cage.

75. The measuring device according to claim 49, wherein the field cage is an electrophoretic field cage.

76. The measuring device according to claim 49, wherein the field cage comprises eight cage electrodes arranged at corner points of a right parallel epiped.

77. The measuring device according to claim 76, wherein the right parallel epiped comprises a substantially horizontal bottom base area, wherein the cage electrodes form the measuring electrodes at the four corner points of this base area.

78. The measuring device according to claim 49, wherein the field cage comprises five cage electrodes, one each at each corner point of a pyramid.

79. The measuring device according to claim 78, wherein the pyramid comprises a bottom base area, wherein the cage electrodes form the measuring electrodes at the four corner points of this base area.

80. The measuring device according to claim 49, wherein the cage electrodes are connected to a control circuit which selects the cage electrodes with the trapping signal.

81. The measuring device according to claim 49, wherein the measuring electrodes are connected to a measuring circuit.

82. The measuring device according to claim 80, wherein the measuring electrodes are connected to a measuring circuit and the cage electrodes are connected to the measuring circuit and to the control circuit by way of a controllable switchboard section, wherein the switchboard section alternately connects the measuring circuit to the measuring electrodes or connects the control circuit to the cage electrodes.

83. The measuring device according to claim 49, wherein
a) said carrier liquid flows within a channel comprising walls;
b) said walls of said channel comprise electrically insulating inner layers and outer layers;
c) at least one of said inner layers comprises an opening at a place of measurement;
d) at least one of said measuring electrodes is retracted between said inner layers and said outer layers, so that edges of the measuring electrodes are exposed to the carrier liquid flowing within said channel.

84. The measuring device according to claim 83, wherein said opening has a circular shape.

85. The measuring device according to claim 83, wherein said electrode for supplying current has a semi-circular shape.

86. The measuring device according to claim 83, wherein said electrode for supplying current is split into a plurality of sections.

87. The measuring device according to claim 86, wherein said sections of said electrode for supplying current do not protrude into said opening within said inner layer.

88. A microfluidic system comprising a measuring device according to claim 49.

89. A cell sorter comprising a microfluidic system according to claim 88.

90. A measuring method for investigating particles suspended in a carrier liquid, comprising the following steps:
a) carrying out an electrical measuring process on at least one particle using at least two measuring electrodes;
b) fixing the particle in a trapping element for the measuring process, wherein said trapping element is a field cage comprising a plurality of cage electrodes, wherein the plurality of cage electrodes form measuring electrodes;
c) supplying a measuring current by way of at least two of the measuring electrodes; and
d) measuring a measuring voltage with at least two of the measuring electrodes.

91. The measuring method according to claim 90, wherein an electrical trapping signal for fixing the particles is applied to the cage electrodes, wherein a frequency of the trapping signal differs from a frequency of the measuring current.

92. The measuring method according to claim 90, wherein the field cage comprises several cage electrodes, wherein the measuring electrodes are selected separately and independently of the cage electrodes.

93. The measuring method according to claim 90, wherein the cage electrodes are driven in pairs in phase opposition.

94. The measuring method according to claim 90, wherein electrical measuring comprises impedance measuring.

95. The measuring method according to claim 94, wherein electrical measuring comprises impedance spectroscopy.

96. The measuring method according to claim 94, wherein electrical measuring comprises tomography measuring.

97. The measuring method according to claim 90, further comprising the following steps:
carrying out reference measuring; and
comparing a result of reference measuring with a result of electrical measuring of the particle.

98. The measuring method according to claim 97, wherein reference measuring is carried out with an empty field cage.
